(19) United States
(12) Patent Application Publication
(10) Pub. No.: US 2015/0020515 A1
(43) Pub. Date: Jan. 22, 2015

(54) DRIVE SYSTEM FOR GROUND ENGAGING MEMBER OF MACHINE

(71) Applicant: Caterpillar Global Mining LLC, Oak Creek, WI (US)

(72) Inventor: Gary L. Dostal, Muskego, WI (US)

(73) Assignee: Caterpillar Global Mining LLC, Oak Creek, WI (US)

(21) Appl. No.: 14/510,154

(22) Filed: Oct. 9, 2014

(51) Int. Cl. F15B 11/16

(52) U.S. Cl. CPC F15B 11/16; F15B 2211/71
USPC 60/420

(57) ABSTRACT

The present disclosure is related to a drive system for a ground engaging member of a machine. The drive system includes first and second hydraulic motors that are disposed parallel to each other. The drive system also include first and second brake valves that are configured to regulate flow of fluid through the first and second hydraulic motors in order to selectively perform braking. The first hydraulic motor is in fluid communication with a first input line and a first output line. The second hydraulic motor is in fluid communication with a second input line and a second output line. A first connection line is configured to fluidly communicate the first input line with the second input line to equalize pressure therebetween. A second connection line is configured to fluidly communicate the first output line with the second output line to equalize pressure therebetween.

### TECHNICAL FIELD

The present disclosure relates to a drive system for a ground engaging member of a machine.

### BACKGROUND

Machines such as, excavators, loaders, track-type tractors, typically include a hydraulic drive to provide propulsion. The hydraulic drive includes one or more hydraulic motors per drive wheel or track assembly. Typically, the hydraulic motors are disposed parallel to each other when more than one hydraulic motor is used per drive wheel or track assembly. Each hydraulic motor is provided with a brake valve. The brake valve regulates a flow of fluid through the corresponding hydraulic motor to perform braking of the machine.

However, the brake valves may not operate synchronously. For example, one of the brake valves may be providing braking to the ground engaging member, while the other brake valve may allow the corresponding hydraulic motor to drive the ground engaging member. The brake valves may also result in unequal levels of braking in the corresponding hydraulic motors. Further, one of the hydraulic motors may experience greater loads due high fluid pressure. Such unsynchronized operation may lead to impaired braking performance, wear and/or damage to the hydraulic motors and various other components of the hydraulic drive.

U.S. Pat. No. 3,788,075 discloses a pressure equalizer valve and a reversible flow logic system that are provided for reversible fluid motors connected in series. The pressure equalizer valve is effective to bypass a small quantity of fluid from the source of fluid pressure to the junction between the motors or from the junction between the motors to a low pressure conduit. This bypassing of fluid is effective to provide equal or proportional operating pressures across the fluid motors, to prevent cavitation of the downstream fluid motor, and to act as a fluid differential for the fluid motors when propelling a vehicle that is making a turn. The logic system provides reversible flow fluid communication between the fluid motors and the equalizer valve so that the equalizer valve functions properly when the fluid motors are reversed.

### SUMMARY OF THE DISCLOSURE

In one aspect of the present disclosure, a drive system for a ground engaging member of a machine is provided. The drive system includes a first hydraulic motor, a first input line and a first output line. The first hydraulic motor is operatively coupled to the ground engaging member. The first hydraulic motor is configured to selectively drive the ground engaging member. The first input line is in fluid communication with the first hydraulic motor. The first input line is configured to selectively supply fluid to the first hydraulic motor. Further, the first input line defines a first input port. The first output line is in fluid communication with the first hydraulic motor. The first output line is configured to selectively receive fluid from the first hydraulic motor. Further, the first output line defines a first output port.

The drive system also includes a second hydraulic motor, a second input line and a second output line. The second hydraulic motor is disposed parallel to the first hydraulic motor and operatively coupled to the ground engaging member. The second hydraulic motor is configured to selectively drive the ground engaging member. The second input line is in fluid communication with the second hydraulic motor. The second input line is configured to selectively supply fluid to the second hydraulic motor. Further, the second input line defines a second input port. The second output line is in fluid communication with the second hydraulic motor. The second output line is configured to selectively receive fluid from the second hydraulic motor. Further, the second output line defines a second output port.

The drive system further includes a first brake valve and a second brake valve. The first brake valve is disposed in fluid communication between the first hydraulic motor and the first output port. The first brake valve is configured to prevent flow of fluid from the first hydraulic motor to the first output port based on a pressure in the first input line in order to achieve braking of the ground engaging member. The second brake valve is disposed in fluid communication between the second hydraulic motor and the second output port. The second brake valve is configured to prevent flow of fluid from the second hydraulic motor to the second output port based on a pressure in the second input line in order to achieve braking of the ground engaging member.

The drive system further includes a first pressure relief valve and a second pressure relief valve. The first pressure relief valve is disposed in fluid communication between the first input line and the first output line. The first pressure relief valve is configured to relieve pressure in the first output line based on a pressure difference between the first input line and the first output line. The second pressure relief valve is disposed in fluid communication between the second input line and the second output line. The second pressure relief valve is configured to relieve pressure in the second output line based on a pressure difference between the second input line and the second output line.

The drive system also includes a first connection line and a second connection line. The first connection line is configured to fluidly communicate the first input line with the second input line in order to equalize pressure between the first input line and the second input line. The second connection line is configured to fluidly communicate the first output line with the second output line in order to equalize pressure between the first output line and the second output line.

Other features and aspects of this disclosure will be apparent from the following description and the accompanying drawings.

### BRIEF DESCRIPTION OF THE DRAWINGS

FIG. 1 illustrates a side view of an exemplary machine 100 having a drive system for a ground engaging member;

FIG. 2 illustrates a schematic diagram of the drive system, according to an embodiment of the invention; and

FIG. 3 illustrates a schematic diagram of the drive system of FIG. 2 in a braking configuration, according to an embodiment of the invention.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

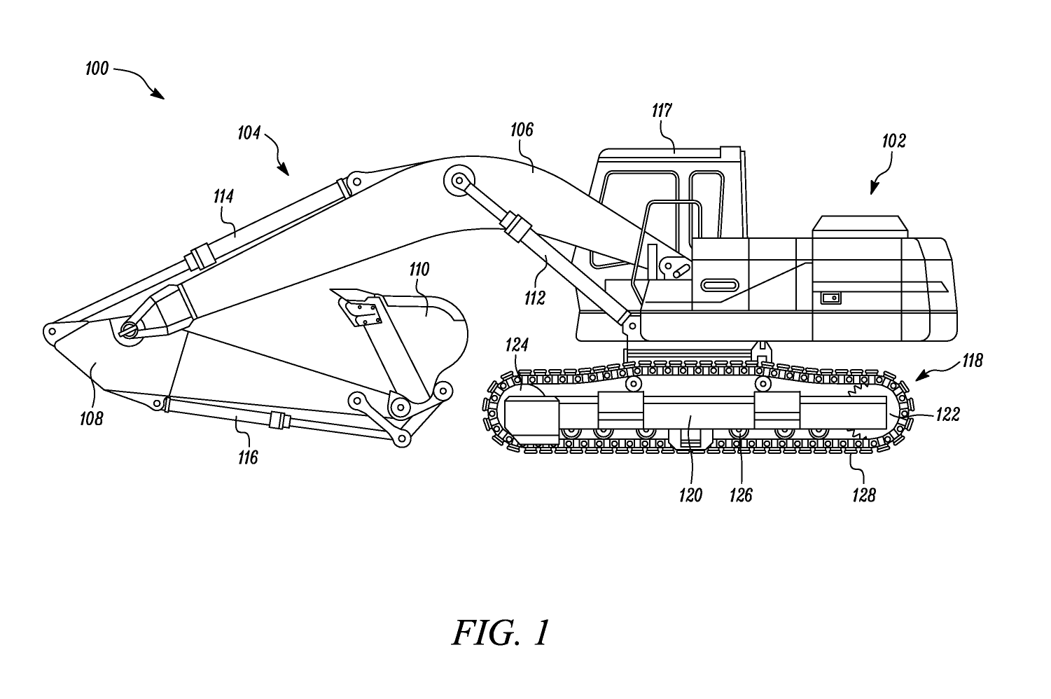

FIG. 1 shows an exemplary machine 100. In the illustrated embodiment, the machine 100 is a hydraulic shovel. Alternatively, the machine 100 may be any machine including, but not limited to, a wheel loader, an excavator, backhoe loader, a dozer, a mining truck, an articulated truck, a track type tractor, a forklift, a crane and the like. Further, the disclosure may be applied to different types of machines used in industries including, but not limited to, construction, transportation, agriculture, forestry, and waste management.

Referring to FIG. 1, the machine 100 includes a main frame 102 and an implement assembly 104 coupled to the main frame 102. The implement assembly 104 includes a boom 106, a stick 108 and a bucket 110. One end of the boom 106 may be pivotally attached to the main frame 102. The stick 108 may be pivotally secured to other end of the boom 106. Further, the bucket 110 may be pivotally coupled to an end of the stick 108. Hydraulic cylinders 112, 114 and 116 may be configured to actuate the boom 106, the stick 108 and the bucket 110, respectively. The bucket 110 may be configured to perform various operations, such as digging and loading. It may be apparent to a person ordinarily skilled in the art that the implement assembly 104 may have different configurations based on the type of operations to be performed by the machine 100.

The machine 100 may further include a power source, such as an internal combustion engine (not shown), which may provide power to various components of the machine 100. For example, the power source may drive the implement assembly 104. The power source may also provide power for propulsion of the machine 100. The machine 100 may also include a cab 117 provided in the main frame 102. The cab 117 may enclose an operator seat (not shown) and multiple control devices (not shown) such as, for example, one or more control levers, foot pedals, and buttons.

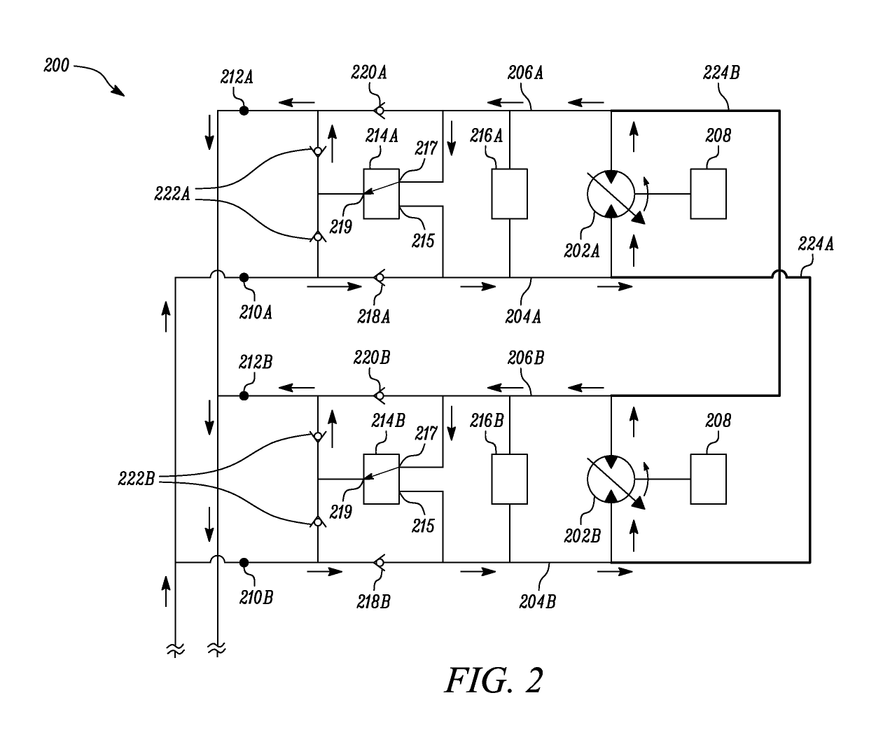

The machine 100 also includes a pair of undercarriage assemblies 118. The undercarriage assembly 118 may be configured to support the main frame 102, and provide propulsion and steering to the machine 100. The undercarriage assembly 118 may include a frame 120, a drive sprocket 122, an idler 124, and multiple rollers 126, and a ground engaging member 128. In an embodiment, a drive system 200 (shown in FIG. 2) may be configured to provide power to the drive sprocket 122. The drive system 200 may be drivably coupled to the power source of the machine 100. Further, the drive sprocket 122 may be configured to drive the ground engaging member 128. Though only one undercarriage assembly 118 is shown in FIG. 2, it may be appreciated that the machine 100 includes a similar undercarriage assembly on another side. In the illustrated embodiment, the ground engaging member 128 includes a continuous track assembly having multiple track links and track shoes. In an alternative embodiment, the ground engaging member 128 may include a continuous rubber track. However, it may be contemplated that the ground engaging member 128 may be wheels.

FIG. 2 illustrates a schematic diagram of the drive system 200, according to an embodiment of the present disclosure. The drive system 200 includes a first hydraulic motor 202A, a first input line 204A and a first output line 206A. The drive system 200 further includes a second hydraulic motor 202B, a second input line 204B and a second output line 206B. The first and second hydraulic motors 202A, 202B are operatively coupled to the drive sprocket 122 (shown via a gearbox 208). Further, the first and second hydraulic motors 202A, 202B are disposed parallel to each other. In the illustrated embodiment, two hydraulic motors are provided per ground engaging member. However, it may be contemplated that the present disclosure may also include a drive system having three or more hydraulic motors per ground engaging member. The gearbox 208 may be configured to regulate a torque transferred to the drive sprocket 122 from the first and second hydraulic motors 202A, 202B. The first and second hydraulic motors 202A, 202B are configured to selectively drive the ground engaging member 128. Alternatively, the first and second hydraulic motors 202A, 202B may be coupled to the corresponding drive sprockets 122 of the two undercarriage assemblies 118 of the machine 100. In an embodiment, each of the first and second hydraulic motors 202A, 202B may be a variable displacement bidirectional hydraulic motor. Each of the first and second hydraulic motors 202A, 202B may also include motor housings configured to enclose various components therein.

The first and second input lines 204A, 204B are in fluid communication with the first and second hydraulic motors 202A, 202B, respectively. Further, the first and second input lines 204A, 204B may be in fluid communication with an outlet of a pump (not shown) and configured to selectively receive pressurized fluid therefrom. Alternatively, the first and second input lines 204A, 204B may be in fluid communication with different pumps. The first and second input lines 204A, 204B are configured to selectively supply pressurized fluid to the first and second hydraulic motors 202A, 202B. The first and second output lines 206A, 206B are also in fluid communication with the first and second hydraulic motors 202A, 202B, respectively. The first and second output lines 206A, 206B are configured to selectively receive fluid from the first and second hydraulic motors 202A, 202B, respectively. The first and second output lines 206A, 206B may be in fluid communication with a reservoir configured to store fluid therein. Alternatively, the first and second output lines 206A, 206B may be in fluid communication with an inlet of the pump. Therefore, the pump, each of the first and second input lines 204A, 204B, each of the first and second output lines 206A, 206B, and each of the first and second hydraulic motors 202A, 202B, may form a closed loop hydraulic circuit. The first and second input lines 204A, 204B, and the first and second output lines 206A, 206B may include one or more fluid pipes, hoses, and the like.

As shown in FIG. 2, the first and second input lines 204A, 204B define a first input port 210A and a second input port 210B, respectively. Further, the first and second output lines 206A, 206B define a first output port 212A and a second output port 212B, respectively. In an embodiment, the first and second input ports 210A, 210B, and the first and second output ports 212A, 212B may be disposed in the motor housings of the first and second hydraulic motors 202A, 202B, respectively. Specifically, the first and second input ports 210A, 210B may allow flow of high pressure fluid into the respective motor housings. Further, the first and second output ports 212A, 212B may allow discharge of low pressure fluid from the respective motor housings. Further, a directional valve system (not shown) may be disposed between the first and second input ports 210A, 210B, the first and second output ports 212A, 212B, and the pump. The directional valve system may be configured to regulate flow of fluid such that a pressure difference is provided between fluid at the first input port 210A and first output port 212A. Similarly, a pressure difference may be provided between the second input port 210B and the second output port 212B. Such pressure differences may drive the first and second hydraulic motors 202A, 202B in a forward direction or a reverse direction based on a desired direction of travel of the machine 100.

The drive system 200 further includes a first brake valve 214A and a second brake valve 214B. In an embodiment, the first and second brake valves 214A, 214B may be counter balance brake valves that are configured to assist in braking or driving the machine 100 in a controlled manner. The first brake valve 214A is disposed in fluid communication between the first hydraulic motor 202A and the first output port 212A. The first brake valve 214A may be configured to prevent flow of fluid from the first hydraulic motor 202A to the first output port 212A based on a pressure in the first input line 204A in order to achieve braking of the ground engaging member 128. Similarly, the second brake valve 214B is disposed in fluid communication between the second hydraulic motor 202B and the second output port 212B. The second brake valve 214B may be configured to prevent flow of fluid from the second hydraulic motor 202B to the second output port 212B based on a pressure in the second input line 204B in order to achieve braking of the ground engaging member 128. In an embodiment, each of the first and second brake valves 214A, 214B may be three-way three-position spool valves. A first brake valve port 215 of each of the first and second brake valves 214A, 214B may be fluidly connected to the first and second input lines 204A, 204B, respectively. A second brake valve port 217 of each of the first and second brake valves 214A, 214B may be fluidly connected to the first and second output lines 206A, 206B, respectively. A third brake valve port 219 of each of the first and second brake valves 214A, 214B may be fluidly connected to the first and second input ports 210A, 210B, and to the first and second output ports 212A, 212B respectively. The spool of each of the first and second brake valves 214A, 214B may be normally spring biased to a first position such that the spool may prevent a flow from the first or second brake valve ports 215, 217 to the third brake valve port 219. When a pressure of fluid in the first or second input lines 204A, 204B exceeds a first threshold pressure, the spool may be displaced from the first position against the spring biasing to a second position such that the second brake valve port 217 may be in fluid communication with the third brake valve port 219. Similarly, when a pressure of fluid in the first or second output lines 206A, 206B exceeds a first threshold pressure, the spool may be displaced from the first position against the spring biasing to a third position such that the first brake valve port 215 may be in fluid communication with the third brake valve port 219. The configuration of the first and second brake valves 214A, 214B, as described above, is exemplary in nature and alternative configurations are possible within the scope of the present disclosure. For example, the first and second brake valves 214A, 214B may be solenoid actuated valves.

The drive system 200 also includes a first pressure relief valve 216A and a second pressure relief valve 216B. The first pressure relief valve 216A is disposed in fluid communication between the first input line 204A and the first output line 206A. The first pressure relief valve 216A is configured to relieve pressure in the first output line 206A based on a pressure difference between first input line 204A and the first output line 206A. Similarly, the second pressure relief valve 216B is disposed in fluid communication between the second input line 204B and the second output line 206B. The second pressure relief valve 216B is configured to relieve pressure in the second output line 206B based on a pressure difference between second input line 204B and the second output line 206B. In an embodiment, each of the first and second pressure relief valves 216A, 216B may be in closed configuration to prevent a flow between the first and second input lines 204A, 204B, and the first and second output lines 206A, 206B, respectively. When a pressure difference between the first and second input lines 204A, 204B, and the first and second output lines 206A, 206B exceeds a second threshold pressure, the first and second pressure relief valves 216A, 216B may allow a flow therethrough. A direction of flow between the first or second input lines 204A, 204B, and the first or second output lines 206A, 206B may be from a high pressure region to a low pressure region. Alternatively, the first relief valve 216A may be fluidly connected such that fluid flows from the first input line 204A to the first output line 206A when the pressure difference between the first input line 204A and the tank exceeds a third threshold pressure. Similarly, the second relief valve 216B may be fluidly connected such that fluid flows from the second input line 204B to the second output line 206B when the pressure difference between the second input line 204B and the tank exceeds the third threshold pressure.

The drive system 200 further includes a first input check valve 218A, a second input check valve 218B, a first output check valve 220A and a second output check valve 220B. The first and second input check valves 218A, 218B is disposed in the first and second input lines 204A, 204B. Further, the first and second input check valves 218A, 218B may allow a unidirectional flow of fluid from the first and second input ports 210A, 210B to the first and second hydraulic motors 202A, 202B, respectively. The first and second output check valves 220A, 220B is disposed in the first and second output lines 206A, 206B. Further, the first and second output check valves 220A, 220B may allow a unidirectional flow of fluid from the first and second output ports 212A, 212B to the first and second hydraulic motors 202A, 202B, respectively.

The drive system 200 also includes two first port check valves 222A and two second port check valves 222B. The first port check valves 222A may be configured to allow a unidirectional flow from the third brake valve port 219 of the first brake valve 214A to the first input and output ports 210A, 212A. Similarly, the second port check valves 222B may be configured to allow a unidirectional flow from the third brake valve port 219 of the second brake valve 214B to the second input and output ports 210B, 212B. The first port check valves 222A may also prevent direct flow of fluid between the first input port 210A and the first output port 212A. Similarly, the second port check valves 222B may prevent direct flow of fluid between the second input port 210B and the second output port 212B.

As shown in FIG. 2, the drive system 200 includes a first connection line 224A configured to fluidly communicate the first input line 204A with the second input line 204B in order to equalize pressure between the first input line 204A and the second input line 204B. The drive system 200 further includes a second connection line 224B configured to fluidly communicate the first output line 206A with the second output line 206B in order to equalize pressure between the first output line 206A and the second output line 206B. In various embodiments, each of the first and second connection lines 224A, 224B may include one or more pipes, hoses, and the like. Moreover, the first connection line 224A may be coupled to the first input and second input lines 204A, 204B via fluid couplings. Similarly, the second connection line 224B may be coupled to the first and second output lines 206A, 206B via fluid couplings.

The drive system 200, as described above, is illustrative in nature and may include various other components, such as one or more accumulators, filters, sensors, and the like. Further, the drive system 200 may be regulated by a controller (not shown) associated with the machine 100. The controller may regulate the drive system 200 based on various parameters, such as user inputs, machine speed, output pressure of the pump, and the like.

An exemplary operation of the drive system 200 will be described hereinafter with reference to FIGS. 1 and 2. The first and second input ports 210A, 210B may receive pressurized fluid from the pump. The first and second input check valves 218A, 218B may allow flow of pressurized fluid through the first and second input lines 204A, 204B to the first and second hydraulic motors 202A, 202B, respectively. Further, pressurized fluid in the first and second input lines 204A, 204B may actuate the spools of the first and second brake valves 214A, 214B to the second position. Hence, the second and third brake valve ports 217, 219 of the first and second brake valves 214A, 214B may be fluidly connected with each other.

Pressurized fluid may drive the first and second hydraulic motors 202A, 202B which in turn provide motive power to the gearbox 208. The first and second hydraulic motors 202A, 202B may be driven in the forward direction. The gearbox 208 may transmit power to the drive sprocket 122. The drive sprocket 122 may drive the ground engaging member 128. Hence, the first and second hydraulic motors 202A, 202B may drive the ground engaging member 128. The first and second output check valves 220A, 220B may prevent flow of fluid from the first and second hydraulic motors 202A, 202B to the first and second output ports 212A, 212B. Therefore, fluid flows to the second brake valve ports 217 of the first and second brake valves 214A, 214B. Fluid exits the first and second brake valves 214A, 214B via the third brake valve ports 219 and flows through the first and second port check valves 222A, 222B. Fluid may flow through the first and second output ports 212A, 212B to the pump inlet or the tank to allow the first and second hydraulic motors 202A, 202B to move in the forward direction. FIG. 2 may therefore correspond to a driving configuration of the drive system 200. Further, a direction of travel of the ground engaging member 128 may be along the forward direction.

Flow of pressurized fluid may be reversed in order to propel the ground engaging member 128 along the reverse direction of travel. During reverse travel, fluid may enter through the first and second output ports 212A, 212B, drive the first and second hydraulic motors 202A, 202B in the reverse direction and exit through the first and second input ports 210A, 210B. In such case, fluid in the first and second output lines 206A, 206B may actuate the spools of the first and second brake valves 214A, 214B to the third position such that the first brake valve ports 215 are fluidly connected to the corresponding third brake valve ports 219. The directional valve system (not shown) may be configured to regulate a direction of fluid flow based on forward or reverse travel of the machine 100. Alternatively, the gearbox 208 may regulate transfer of power from the first and second hydraulic motors 202A, 202B to the ground engaging member 128 based on the desired direction of travel.

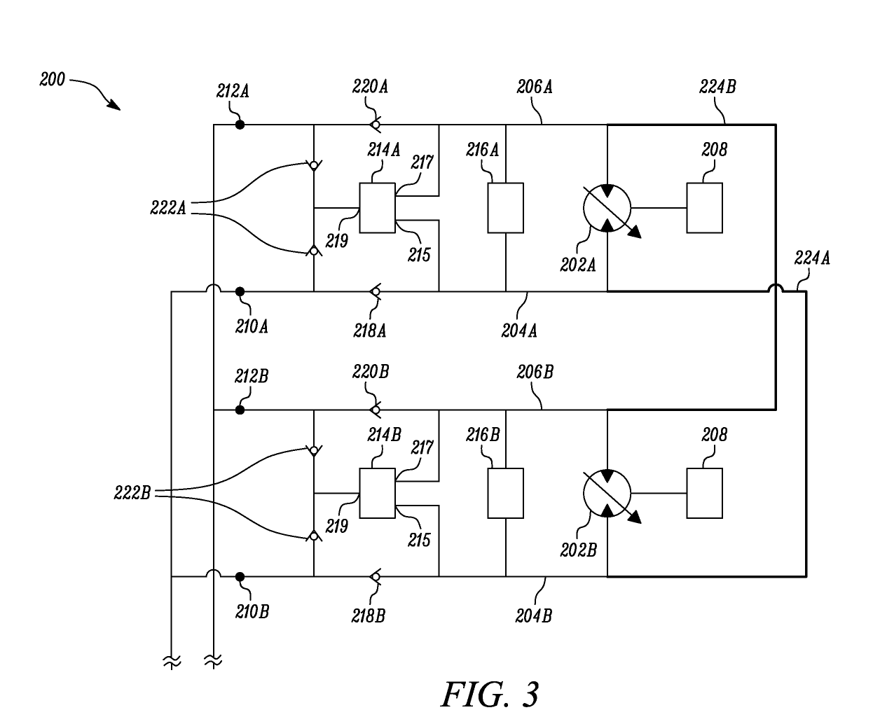

FIG. 3 illustrates the drive system 200 in a braking configuration, according to an embodiment of the present disclosure. Braking may be performed based on a user input, for example, actuation of a brake pedal or a ground speed pedal that reduces pressure in the first and second input lines 204A, 204B. Braking may also be performed in order to keep the machine 100 stationary on a sloped surface. During braking, an output pressure of the pump may be reduced. Consequently, a pressure of fluid in the first and second input lines 204A, 204B may decrease below the first threshold pressure. The spools of the first and second brake valves 214A, 214B may be moved by spring force to the first position such that the first and second brake valve ports 215, 217 may be fluidly disconnected from the corresponding third brake valve ports 219. Fluid flowing through the first and second hydraulic motors 202A, 202B may therefore be restricted from reaching the first and second output ports 212A, 212B by the first and second brake valves 214A, 214B, and the first and second output check valves 220A, 220B, respectively. The first and second input check valves 218A, 218B may also prevent fluid from flowing back to the pump. Hence, fluid may accumulate between the first and second brake valves 214A, 214B, and the first and second hydraulic motors 202A, 202B resulting in an increase in pressure in the first and second output lines 206A, 206B. This increase in pressure may retard rotation of the first and second hydraulic motors 202A, 202B, thereby applying braking torque on the ground engaging member 128 via the gearbox 208.

When pressure in the first and second input lines 204A, 204B increase beyond the first threshold pressure, the spools may be actuated to the second position, and allow fluid to flow through the first and second brake valves 214A, 214B to the first and second output ports 212A, 212B. Fluid may therefore drive the first and second hydraulic motors 202A, 202B in the forward direction. The ground engaging member 128 may also be driven to propel the machine 100 along the forward direction of travel.

Additionally, if the pressure difference between the first output line 206A and the first input line 204A increases beyond the second threshold pressure, the first pressure relief valve 216A may allow flow of fluid between the first output line 206A and the first input line 204A. Alternatively, if the pressure difference between the first output line 206A and the tank increase beyond the third threshold pressure, first pressure relief valve 216A may allow flow of fluid from the first output line 206A to the first input line 204A. Similarly, if the pressure difference between the second output line 206B and the second input line 204B increases beyond the second threshold pressure, the second pressure relief valve 216B may allow flow of fluid between the second output line 206B and the second input line 204B. Alternatively, if the pressure difference between the second output line 206B and the tank increase beyond the third threshold pressure, the second pressure relief valve 216B may allow flow of fluid from the second output line 206B to the second input line 204B.

Braking may also be achieved when the first and second brake valves 214A, 214B are in the first position and fluid accumulates in the first and second input lines 204A, 204B due to intake of fluid via the first and second output ports 212A, 212B, respectively. Fluid pressure in the first and second input lines 204A, 204B may retard rotation of the first and second hydraulic motors 202A, 202B.

### INDUSTRIAL APPLICABILITY

The present disclosure relates to the drive system 200 for the machine 100. The drive system 200 includes the first and second hydraulic motors 202A, 202B disposed in parallel to each other. In an example, the first and second brake valves 214A, 214B may regulate flow of fluid through the first and second hydraulic motors 202A, 202B to retard rotation thereof based on pressures in the first and second input lines 204A, 204B, respectively. In another example, the first and second brake valves 214A, 214B may regulate flow of fluid through the first and second hydraulic motors 202A, 202B to retard rotation thereof based on pressures in the first and second output lines 206A, 206B, respectively.

The first connection line 224A may equalize pressure between the first and second input lines 204A, 204B. Further, the second connection line 224B may equalize pressure between the first and second output lines 206A, 206B. Such equalization of pressures may ensure that the spools of the first and second brake valves 214A, 214B may be actuated synchronously. Further, the first and second brake valves 214A, 214B may be actuated to substantially equal levels. Thus, the first and second brake valves 214A, 214B may cause driving or braking of the first and second hydraulic motors 202A, 202B in unison. Further, braking of the first and second hydraulic motors 202A, 202B may be substantially equal. This may result in reliable braking, and reduce wear and/or damage to various components of the drive system 200 including the first and second hydraulic motors 202A, 202B, the gearbox 128, and the like.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A drive system for a ground engaging member of a machine, the drive system comprising:
a first hydraulic motor operatively coupled to the ground engaging member, the first hydraulic motor configured to selectively drive the ground engaging member;
a first input line in fluid communication with the first hydraulic motor and configured to selectively supply fluid to the first hydraulic motor;
a first output line in fluid communication with the first hydraulic motor and configured to selectively receive fluid from the first hydraulic motor, the first output line defining a first output port;
a second hydraulic motor disposed parallel to the first hydraulic motor and operatively coupled to the ground engaging member, the second hydraulic motor configured to selectively drive the ground engaging member;
a second input line in fluid communication with the second hydraulic motor and configured to selectively supply fluid to the second hydraulic motor;
a second output line in fluid communication with the second hydraulic motor and configured to selectively receive fluid from the second hydraulic motor, the second output line defining a second output port;
a first brake valve disposed in fluid communication between the first hydraulic motor and the first output port, the first brake valve configured to prevent flow of fluid from the first hydraulic motor to the first output port based on a pressure in the first input line in order to brake the ground engaging member;
a first pressure relief valve disposed in fluid communication between the first input line and the first output line, the first pressure relief valve configured to relieve pressure in the first output line based on a pressure difference between the first input line and the first output line;
a second brake valve disposed in fluid communication between the second hydraulic motor and the second output port, the second brake valve configured to prevent flow of fluid from the second hydraulic motor to the second output port based on a pressure in the second input line in order to brake the ground engaging member;
a second pressure relief valve disposed in fluid communication between the second input line and the second output line, the second pressure relief valve configured to relief pressure in the second output line based on a pressure difference between the second input line and the second output line;
a first connection line configured to fluidly communicate the first input line with the second input line in order to equalize pressure between the first input line and the second input line; and
a second connection line configured to fluidly communicate the first output line with the second output line in order to equalize pressure between the first output line and the second output line.
